(19) United States
(12) Patent Application Publication
(10) Pub. No.: US 2008/0237516 A1
(43) Pub. Date: Oct. 2, 2008

(54) Sensing Device

(75) Inventor: Birger Hansson, Akarp (SE)

Correspondence Address: MERCHANT & GOULD PC, P.O. BOX 2903, MINNEAPOLIS, MN, 55402-0903, US

(73) Assignee: BALDWIN JIMEK AB, Arlov (SE)

(21) Appl. No.: 10/585,701

(22) PCT Filed: Dec. 21, 2004
(86) PCT No.: PCT/SE2004/001947

§ 371 Date: Dec. 20, 2007

(30) Foreign Application Priority Data
Jan. 12, 2004 (SE) 0400032-9

(51) Int. Cl. F16K 31/02

(52) U.S. Cl. 251/129.01

(57) ABSTRACT

An electronically controlled valve (100) for supplying a controlled amount of fountain solution (FS) or cleaning agent to rollers in a printing machine includes sensing means (200, 220E, 220R, 230, P) for providing an output signal, when the valve (100) is open.

### FIELD OF THE INVENTION

The present invention relates to an electronically controlled valve for supplying fountain solution to rollers in a printing machine. The valve comprises a plunger co-operating with a valve seat for controlling the amount of fountain solution leaving the valve.

Further, the invention relates to a method for controlling an actual opening timing for a plunger (130) of an electromagnetic valve (100) for supplying fountain solution to rolls in a printing machine. The plunger (130) co-operates with a valve seat (120) for opening the valve (100), hence delivering an amount of the fountain solution from the valve.

### PRIOR ART

In the art of paper printing, e.g. offset printing, it is very common to use a fountain solution that moistens the printing rolls. This is done in order to get a better printing result.

There are many known devices for supplying fountain solution to the printing rolls, see e.g. the published Swedish patent application 0201483-5. Basically, the device according to the prior art comprises a number of electro-magnetic spray valves, which are provided in a row. The spray valves are controlled electromagnetically, i.e. a voltage and a current are applied to a coil, which moves a plunger. The movement of the plunger opens a valve, which makes it possible for fluid to pass through the valve and be sprayed from a nozzle. By changing the “duty cycle” of the voltage and current through the coil, i.e. the ratio between the time the spray valve is open and the time it is closed, it is possible to vary the amount of liquid that is sprayed from the nozzle per time unit. In order to minimise spray mist from the spray valves entering the surroundings, a cover extends from the valve row to a location as close to the roll to be sprayed as possible.

There is, however, a problem with the prior art device; in order to get a spray pattern from the spray row that is as uniform as possible, it is important that every spray valves in the row delivers an equal amount of liquid to be sprayed per time unit. As mentioned earlier, the amount to be sprayed is controlled by means of the duty cycle of the voltage and current supplied to the coil. Tests have, however, shown that both the time from the supply of voltage/current to the coil to the actual opening of the valve and the time from coil voltage/current shut-off to the actual closing time vary significantly from valve to valve, and over time. A test performed on six individual valves showed that the difference in delivered liquid varied more than forty percent from the individual valve that delivered the most liquid, to the individual valve that delivered the least liquid. About five percent can be blamed on nozzle variation, but most of the variation emanates from the above-mentioned varying delay between voltage/current supply to the coil and actual opening of the valve.

### SUMMARY OF THE INVENTION

The above-mentioned and other problems are solved according to the invention by the arrangement of sensing means for providing an output signal of the plunger in a predetermined position.

Further, the above-mentioned problems and other problems are solved according to the invention by a method comprising the steps of arranging means for sensing the position of the plunger (130) and using an output signal from the sensing means for adaptive control of a signal opening the valve.

Preferred embodiments of the invention are defined in the dependent claims.

### BRIEF DESCRIPTIONS OF THE DRAWINGS

In the following, some preferred embodiments of the invention will be described, with reference to the accompanying drawings, wherein;

FIG. 1 is a schematic cross-sectional view of a first embodiment of a spray valve provided with an optical sensor based on reflection,

FIG. 2 is a schematic cross-sectional view of a second embodiment of a spray valve provided with an optical sensor based on transmission,

FIG. 3 is a schematic cross-sectional view of a third embodiment of a spray valve provided with a Hall-effect sensor or an accelerometer and

FIG. 4 is a schematic cross-sectional view of a fourth embodiment of a spray valve provided with a pressure sensor.

### DESCRIPTION OF PREFERRED EMBODIMENTS

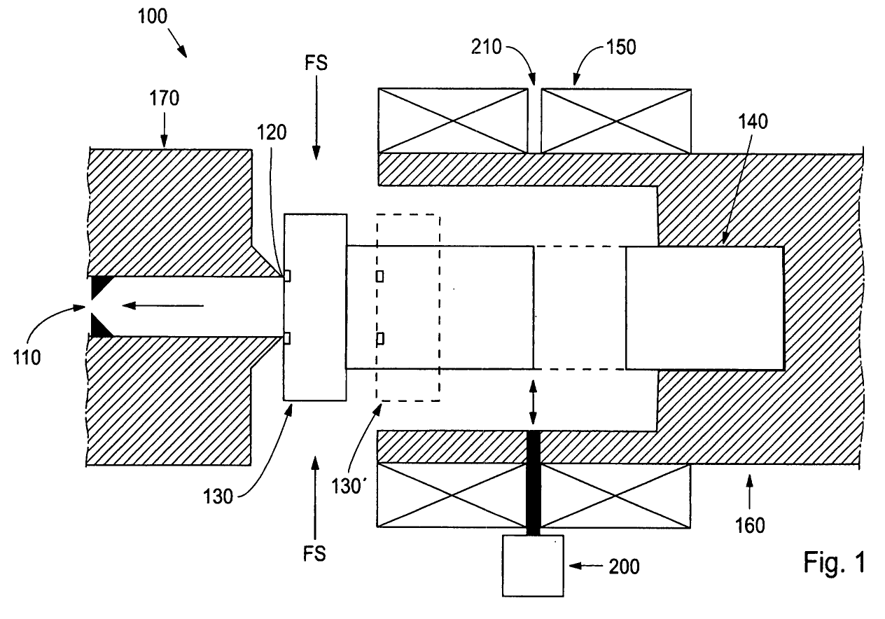

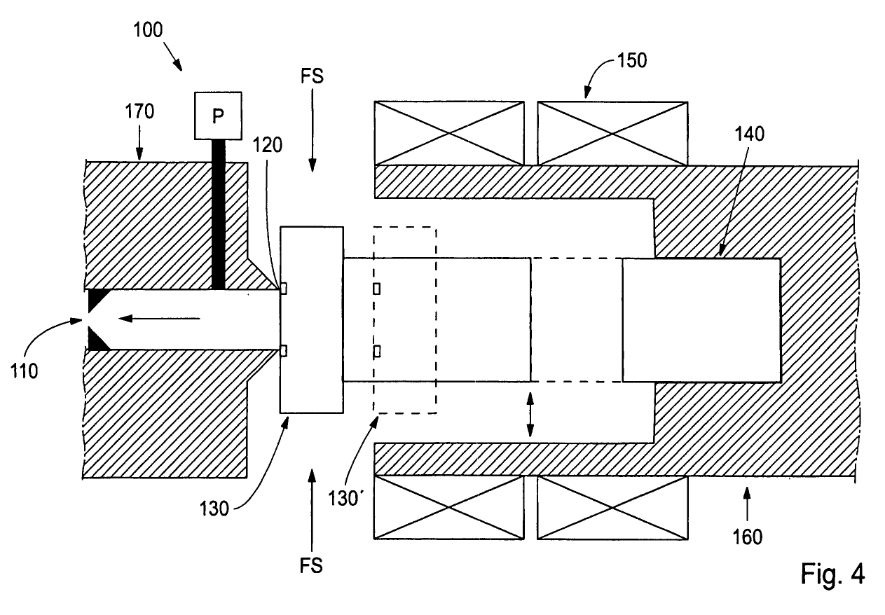

As can be seen by briefly reviewing the drawings, there are many similarities between FIGS. 1, 2, 3 and 4. Hence, a general description concerning all figures will be given prior to the description of the preferred embodiments of the invention.

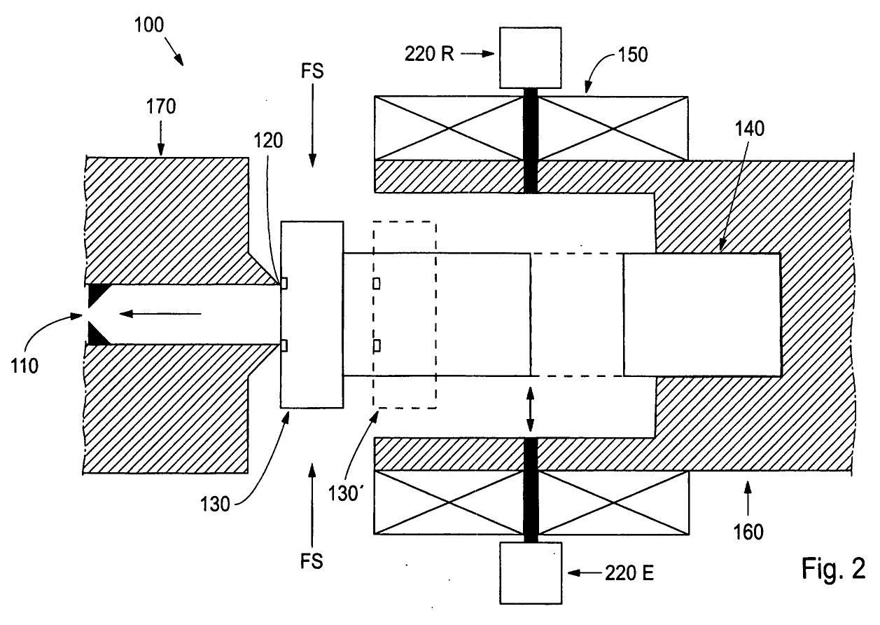

In FIGS. 1, 2 3, and 4, a spray valve 100 comprising a nozzle 110, a valve seat 120, a plunger 130, 130′, a valve stem 140 and a double coil 150 is shown. The spray valve 100 further comprises a plunger housing 160 and a nozzle housing 170. Fountain solution or any other suitable liquid, e.g. for cleaning, is fed into the nozzle housing 170, as indicated by arrows FS. The nozzle housing 170 has fastening means (not shown) on its outer periphery.

During operation, a voltage/current is fed to the double coil 150. This leads to a magnetic field being formed inside the coil. As is well known by persons skilled in the art, such a magnetic field (amplified by the valve stem 140) will pull the plunger 130, 130′ towards the centre of the double coil 150, creating a lower reluctance of the coil. In the drawings, this is shown by the plunger being moved from the position indicated by 130 to the position indicated by 130′ (dashed lines).

In the plunger position indicated by 130, the plunger is resting against the valve seat 120 and seals hence against any fountain solution FS that otherwise would flow towards the nozzle 110, whereas in the position indicated by 130′, fountain solution will be able to pass over the valve seat.

As implied above, in order to control the amount of fountain solution that is supplied to the nozzle, the duty cycle of the electromagnetic coil is controlled; if a large amount of fountain solution is to be supplied, long periods of voltage/current supply to the coil are followed by short or no periods of no voltage/current supply. If smaller amounts of fountain solution are to be supplied, short periods of voltage/current supply to the coil are followed by long periods of no voltage/current supply. As mentioned, the delay from the voltage/current to the actual opening varies significantly between the valves, which results in an uneven distribution of sprayed liquid.

According to the embodiments shown in FIGS. 1, 2, 3 and 4, including sensing means solves this problem. According to a first embodiment, shown in FIG. 1, sensing means 200 is arranged in a space 210 provided in the double coil 150. The sensor 200 is able to sense a position of the plunger 130, 130′. This enables sensing of the actual opening timing for the valve. The sensing means 200 according to the first embodiment may be an optical reflection sensor but may also be for example an ultrasound sensor, a magnetic sensor or the like. The important feature according to the first embodiment is that the sensor needs access from one side only.

According to a second embodiment sensing means 220 is divided into two portions, 220E and 220R. The sensing means portion 220E emits some kind of signal (e.g. light or any other kind of electromagnetic radiation), that can pass to the sensing means portion 220R when the plunger 130 is in the closed position (130), but will be blocked when the plunger is in the position corresponding to an open valve (130′). The sensor arrangement 220 according to the second embodiment is a so-called transmission set-up.

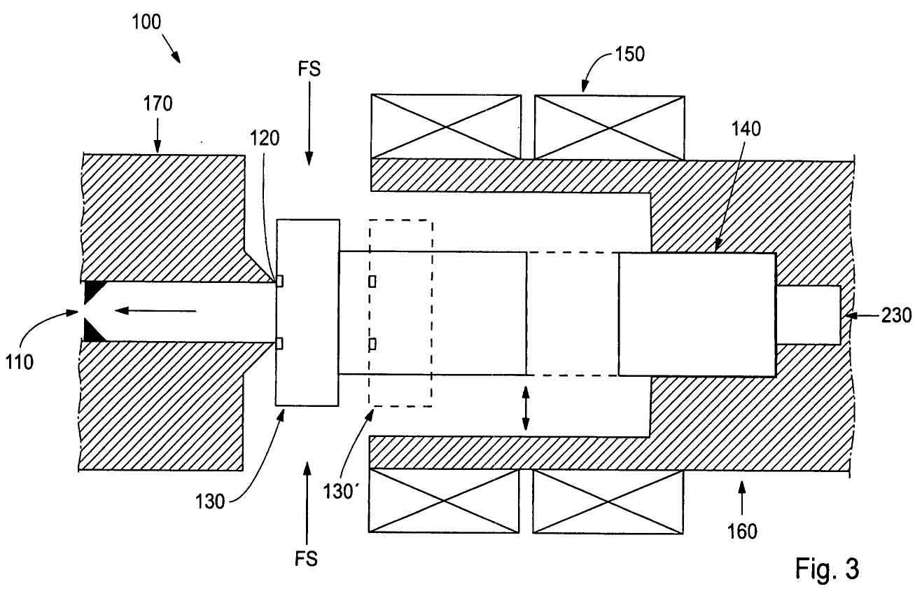

In a third embodiment, according to FIG. 3, sensing means 230 is attached to one end of the valve stem 140. In this case the sensing means 230 could be e.g. a Hall-effect sensor (sensing differences in the magnetic field) or an accelerometer (sensing the acceleration of the plunger 140). For the third embodiment it is feasible to use a single coil (not shown) instead of the double coil 150.

For a fourth embodiment of the present invention, a pressure sensor P is provided in a channel connecting the valve seat 120 and the nozzle 110. The pressure sensor P will then measure the pressure supplied to the nozzle 110. The pressure is a very clear indication of whether the valve is open; when the valve is closed, the pressure in the channel will be equal to the pressure outside the nozzle, whereas it will be significantly higher when the valve is open. There are many types of pressure sensors available on the market. A preferred choice is a piezoelectric sensor, since such sensors are reliable, sensitive and not too heavily priced. Depending on the demands on response time and sensitivity, a piezoelectric sensor can be both resistance coupled and charge coupled. A resistance coupling is much faster and more precise, but fails to give an absolute value of the pressure, which is unnecessary in this application. Resistance coupled piezoelectric sensors can, on the other hand, give an absolute pressure, but are slower regarding response time and less sensitive.

Depending on the longitudinal position of the sensors according to the first and second embodiments, it is possible to obtain a signal representative of a certain position of the plunger 130. This position could be e.g. a position corresponding to the plunger 130 being 50 or 70 percent open, depending on the plunger position where a full flow of liquid over the valve seat 120 is present.

Regarding the actual control of the electromagnetic valves in the row, it is preferred to have some kind of adaptive control. Adaptive control means in this context that there is feedback to control means (not shown) about the actual opening timing of the valve opening. By using the information on actual valve timing, it is possible to adjust the opening commandos from the control means so that the actual valve opening corresponds to the desired value.

From an economical standpoint, it may be advantageous to use sensing means for control of the actual opening of electromagnetic valves printing machines; on the prior art devices, much effort is directed towards improvement of the tolerances in order to get smaller variations between the individual valves. The valves according to the present invention can, however, be manufactured with larger tolerances and will still give a more precise result than the valves according to the prior art.

In the previously described embodiments, the valve has been regarded as being an electromagnetic valve. The invention is, however, applicable on other types of valves, e.g. electro-static valves, piezo-electric valves, magnetostrictive valves, thermo-electrical valves.

It should be noted that the above description of an embodiment should not be limiting for the scope of the invention. The scope of the invention is defined by the appended claims.

1. An electronically controlled valve for supplying a controlled amount of fountain solution or cleaning agent to rollers in a printing machine comprising sensing means for providing an output signal when the valve is open.

2. The electromagnetic valve according to claim 1, wherein the sensing means is an optical sensing means.

3. The electromagnetic valve according to claim 1, wherein the sensing means is an accelerometer.

4. The electromagnetic valve according to claim 1, wherein the sensing means is a Hall-effect sensor.

5. The electromagnetic valve according to claim 1, wherein the sensing means is a pressure sensor

6. The electromagnetic valve according to claim 1, wherein adaptive control means is provided for controlling opening of the valve in response to the output signals from the sensing means.

7. A method for controlling an actual opening timing for a valve supplying fountain solution or cleaning agent to rolls in a printing machine, comprising the steps of:
arranging means for sensing whether the valve is open and
using an output signal from the sensing means for adaptive control of a signal opening the valve.
